(19) United States
(12) Patent Application Publication
(10) Pub. No.: US 2023/0289686 A1
(43) Pub. Date: Sep. 14, 2023

(54) CARPOOLING SUPPORT METHOD, CARPOOLING SUPPORT DEVICE, AND CARPOOLING SUPPORT SYSTEM

(71) Applicant: Nissan Motor Co., Ltd., Kanagawa (JP)

(72) Inventors: Takehiro Miyoshi, Kanagawa (JP); Kotaro Chiba, Kanagawa (JP); Shuji Miyanaga, Kanagawa (JP); Sho Tanaka, Kanagawa (JP)

(73) Assignee: Nissan Motor Co., Ltd., Kanagawa (JP)

(21) Appl. No.: 17/927,493

(22) PCT Filed: May 27, 2020
(86) PCT No.: PCT/JP2020/020984

§ 371 Date: Nov. 23, 2022

(51) Int. Cl. G06Q 10/0631; G06Q 10/02; G06Q 50/30

(52) U.S. Cl. CPC G06Q 10/06315; G06Q 10/02; G06Q 50/30

(57) ABSTRACT

A carpooling support method, a carpooling support device, and a carpooling support system generate a vehicle allocation plan candidate of a vehicle for a first user (supporter), based on a vehicle allocation request, transmits a support request for the first user to consent to a predetermined support for a second user (support recipient) of the vehicle, to an operation terminal, acquire a support availability data from the operation terminal, where the support availability data indicating whether consent to the predetermined support is possible, and record the vehicle allocation plan candidate and the support availability data in association with each other.

### TECHNICAL FIELD

The present invention relates to a carpooling support method, a carpooling support device, and a carpooling support system.

### BACKGROUND ART

In Patent Literature 1, in order to automatically formulate a transfer plan that reduces the burden on a care recipient at the time of transfer, a technique for making plans is proposed which determines the service provider’s decision, seat allocation, and transfer route based on the care recipient information.

### CITATION LIST

### Patent Literature

Patent Literature 1: Japanese Patent Laid-Open Publication No. 2006-201990

### SUMMARY OF INVENTION

### Technical Problem

However, the technique described in Patent Literature 1 is intended to reduce the burden of riding only on the care recipient and is not a technique widely targeted at users who need support. Further, the technique described in Patent Literature 1 is a technique premised on the use of a transfer service in which a staff member who transfers the care recipient is provided, and the technique cannot reduce the burden on the user when using a transfer service in which a staff member is not provided.

The present invention has been made in view of the above problems, and an object of the present invention is to provide a carpooling support method, a carpooling support device, and a carpooling support system, reflecting the cooperative relationship between users in a vehicle allocation plan and capable of reducing the burden received by a user of the vehicle allocation service who needs support.

### Solution to Problem

In order to solve the above problems, a carpooling support method, a carpooling support device, and a carpooling support system, according to an aspect of the present invention, generate a vehicle allocation plan candidate of a vehicle for a first user (supporter), based on a vehicle allocation request, transmits a support request for the first user to consent to a predetermined support for a second user (support recipient) of the vehicle, to an operation terminal, acquire a support availability data from the operation terminal, where the support availability data indicating whether consent to the predetermined support is possible, and record the vehicle allocation plan candidate and the support availability data in association with each other.

### Advantageous Effects of Invention

According to the present invention, it is possible to reflect the cooperative relationship between users in a vehicle allocation plan and to reduce the burden received by a user of the vehicle allocation service who needs support.

### BRIEF DESCRIPTION OF DRAWINGS

FIG. 1 is a block diagram illustrating a configuration of a carpooling support system according to an embodiment of the present invention.

FIG. 2 is a flowchart illustrating a processing procedure related to a first user (supporter) side in a carpooling support according to the embodiment of the present invention.

FIG. 3 is a flowchart illustrating a processing procedure related to a second user (support recipient) side in a carpooling support according to the embodiment of the present invention.

### DESCRIPTION OF EMBODIMENTS

Next, embodiments of the present invention will be described in detail with reference to the drawings. In the description, the same items are designated by the same reference numerals and duplicate description will be omitted.

### Configuration of Carpooling Support System

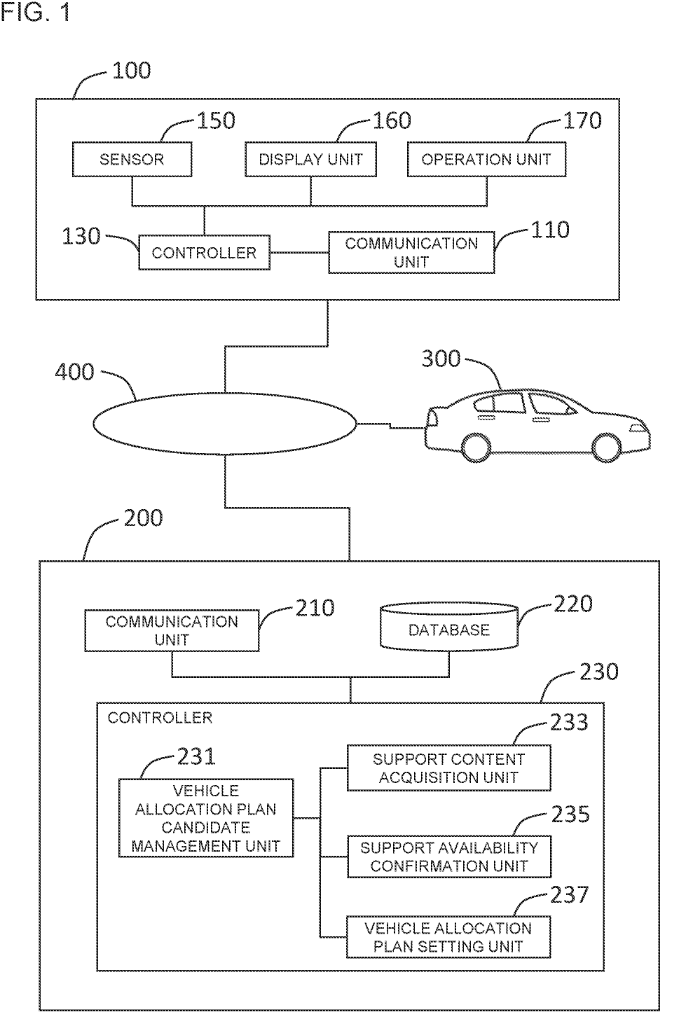

FIG. 1 is a block diagram illustrating a configuration of a carpooling support system according to an embodiment of the present invention. As shown in FIG. 1, the carpooling support system includes a terminal 100 (operation terminal), a vehicle allocation server 200 (carpooling support device), and a vehicle 300, which are connected to each other by wireless or wired network 400.

The terminal 100 receives a vehicle allocation request from the user and transmits the received vehicle allocation request. Examples of the terminal 100 include mobile terminals (smartphones, tablets, etc.) that users use on a daily basis.

The users who use the carpooling support system include a first user who is a supporter and a second user who is a support recipient who receives a predetermined support from the first user. The first user and the second user may have different terminals 100, or the first user and the second user may share the same terminal 100.

Examples of the support recipient include passengers who are equal to or older than a predetermined age (elderly people), passengers who are equal to or younger than a predetermined age (children), passengers of a predetermined gender, or passengers who require a predetermined care (persons with physical disabilities, etc.).

The vehicle allocation server 200 (carpooling support device) acquires information on the user’s vehicle allocation request and the vehicle 300, and generates a vehicle allocation plan candidate and a vehicle allocation plan according to the vehicle allocation request based on the acquired information. Then, the generated vehicle allocation plan candidate and the vehicle allocation plan are output. The details of the vehicle allocation plan candidate and the generation of the vehicle allocation plan will be described later.

The vehicle 300 is a vehicle that provides a means of transportation to a destination (user’s destination) designated by the user, and examples thereof include an autonomous driving vehicle. In addition, examples of the vehicle 300 include various means of transportation such as manned / unmanned taxis, buses, and trucks. It is assumed that multiple vehicles are registered in the carpooling support system

The network 400 includes, for example, the Internet. The network 400 may use a mobile communication function such as 4G / LTE or 5G.

Although not shown in FIG. 1, a management server of a servicer (for example, a vehicle allocation service provider such as DeNA (registered trademark) or UBER (registered trademark)) may be connected to the network 400 to form a part of the carpooling support system.

In this case, the vehicle allocation request transmitted from the terminal 100 may be processed by the management server of the servicer, and the vehicle allocation request after the processing may be transmitted to the vehicle allocation server 200. Further, the information of the vehicle 300 may be processed by the management server of the servicer, and the processed information of the vehicle 300 may be transmitted to the vehicle allocation server 200.

Further, the information of the vehicle 300 output from the vehicle allocation server 200 may be processed by the management server of the servicer, and the processed information may be transmitted to the terminal 100.

In the following, for the sake of simplification of the explanation, the management server of the servicer is omitted, it is assumed that the terminal 100 can communicate with the vehicle allocation server 200 in both directions via the network 400. Further, it is assumed that the vehicle 300 can communicate with the vehicle allocation server 200 in both directions via the network 400.

### Configuration of Terminal

Next, the terminal 100 (operation terminal) will be described. As shown in FIG. 1, the terminal 100 according to the present embodiment includes a sensor 150, a display unit 160, an operation unit 170, a communication unit 110, and a controller 130.

The sensor 150 is composed of a plurality of sensor groups, and includes a position detection sensor that acquires position information of the terminal 100. For example, the position detection sensor is a sensor that measures an absolute position such as GPS (Global Positioning System).

In addition, the sensor 150 may include an environment sensor that acquires environmental information regarding the environment in which the terminal 100 is placed. For example, the environment sensor is a temperature sensor, a humidity sensor, a vibration sensor, an acceleration sensor, a microphone, or the like.

The display unit 160 displays information on the vehicle 300 provided by the carpooling support system, and information on vehicle allocation plan candidates and the vehicle allocation plan generated by the vehicle allocation server 200. Further, the display unit 160 may display information on the predetermined support (or support content) required by the second user, information on the support request for requesting the first user to consent to the predetermined support for the second user, and information indicating whether or not consent to the predetermined support is possible (support availability data). In addition, the display unit 160 may display information about the first user, the second user, and the like.

The information displayed by the display unit 160 is acquired from the vehicle allocation server 200 via the network 400 by the communication unit 110 described later. In addition, the display unit 160 may display route information necessary for heading to a point where the vehicle 300 meets, and guidance information for guiding the user’s movement to the point.

Here, the predetermined support may include, for example, assistance to the second user when the second user boards or alights the vehicle to be allocated (assistance for the operation of boarding or alighting by the second user, assistance for the operation of loading luggage on or unloading luggage from the vehicle by the second user, etc.).

In addition, the predetermined support may include the transfer of right regarding the vehicle to be allocated (a right to occupy a seat of the vehicle, a right to occupy a space of the vehicle, etc.) to the second user. For example, if the second user is a wheelchair user, it may be necessary to occupy the seat or space in the vehicle for loading the wheelchair. In order to meet such a need, the right regarding the vehicle to be allocated may be transferred from the first user to the second user.

Further, the predetermined support may include generating a vehicle allocation plan that prioritizes the second user over the first user, and may include generating a vehicle allocation plan that prioritizes boarding or alighting of the second user over boarding or alighting of the first user. In a case of generating the vehicle allocation plan that prioritizes the first user over the second user, a position where it is difficult for the second user to board or alight may be set as the boarding or alighting place of the second user. In order to avoid such a case, the vehicle allocation plan that prioritizes the second user over the first user is generated

In addition, the predetermined support may include generating a vehicle allocation plan that prioritizes a seat reservation by the second user over a seat reservation by the first user. For example, in a case where the second user is a person with a disability or the like, it may be difficult to move from a doorway of the vehicle to the seat available in the vehicle in the vehicle. In order to avoid such a case, the vehicle allocation plan that prioritizes the seat reservation by the second user is generated.

In addition, the predetermined support may include adjusting an internal environment (temperature, humidity, lighting intensity, speaker volume, content displayed on in-vehicle monitor or played from speakers) of the vehicle to be allocated, by prioritizing wishes of the second user over wishes of the first user.

The operation unit 170 receives user operations corresponding to various commands from the user to the carpooling support system. For example, the operation unit 170 may be an input interface having a plurality of buttons or may be a touch panel having a touch interface.

More specifically, the display unit 160 may display an icon expressed by a picture or a symbol so that the user can operate it, the operation unit 170 may receive user operations when the user touches or drags the displayed icon.

In addition, in a case where the user who operates the terminal 100 is the second user, the operation unit 170 may receive information indicating predetermined support required by the second user based on the user’s operation. Further, in a case where the user who operates the terminal 100 is the first user, the operation unit 170 may receive support availability data based on the user’s operation.

Further, the operation unit 170 may receive information (plan consent approval / disapproval data) indicating whether or not to agree with the vehicle allocation plan candidate based on the user’s operation.

The communication unit 110 transmits information to the network 400 and/or receives information from the network 400. The communication unit 110 stores the information acquired from the network 400 in a memory or the like (not shown), and outputs predetermined information such as the vehicle allocation request and environmental information to the network 400. For example, the communication unit 110 may be an in-vehicle device having a 4G / LTE mobile communication function, or may be an in-vehicle device having a Wi-Fi communication function.

The controller 130 is connected to the sensor 150, the display unit 160, the operation unit 170, and the communication unit 110. Information from the sensor 150, the operation unit 170, and the communication unit 110 is input to the controller 130. Information to the display unit 160 and the communication unit 110 is output from the controller 130.

The controller 130 is a general-purpose microcomputer including a CPU (central processing unit), a memory, and an input / output unit. A computer program (carpooling support program) for functioning as a part of the terminal 100 is installed in the controller 130. By executing the computer program, the controller 130 controls the display unit 160 and the communication unit 110.

Various types of information processing included in the controller 130 may be realized by software or may be realized by dedicated hardware

As for the information processing performed by the controller 130, in particular, the controller 130 acquires the vehicle allocation request from the user based on the user’s operation on the operation unit 170. For example, the vehicle allocation request may include designation of a destination to which the user plans to go by using the vehicle 300. In addition, the vehicle allocation request may include designation of boarding capacity, specifications, types, etc. of the vehicle 300.

In addition, the vehicle allocation request may include user attribute information. The user attribute information may include information such as user preference, age, gender, occupation type, physical characteristics, presence / absence of events before and after the vehicle allocation request, event type, and the like. For example, in a case where the terminal 100 is a mobile terminal (smartphone, tablet, etc.) that the user uses on a daily basis, the application as the carpooling support program may acquire above attribute information by coordinating an SNS (social network service) or other cloud service.

In addition, in a case where the user who operates the terminal 100 is the second user, the vehicle allocation request may include information indicating predetermined support required by the second user. Further, in a case where the user who operates the terminal 100 is the first user, the vehicle allocation request may include support availability data.

The information indicating the predetermined support required by the second user may be set by the controller 130 based on the attribute information of the user without depending on the operation of the user.

### Configuration of Vehicle Allocation Server

The vehicle allocation server 200 (carpooling support device) will be described. The vehicle allocation server 200 according to the present embodiment includes a communication unit 210 (communication means), a database 220, and a controller 230.

The communication unit 210 transmits information to the network 400 and/or receives information from the network 400. The communication unit 210 acquires predetermined information from the network 400, wherein predetermined information is such as the vehicle allocation request transmitted from the terminal 100, information indicating the predetermined support required by the second user, information indicating whether or not consent to the predetermined support for the second user is possible, and vehicle information transmitted from the vehicle 300 (for example, position information of the vehicle 300, remaining fuel amount of the vehicle 300, status information indicating whether or not the vehicle allocation service is being provided), and the communication unit 210 records the acquired information in the database 220.

The database 220 stores the information acquired by the communication unit 210. In addition, the database 220 may store the user’s past vehicle allocation requests, the usage history and frequency of the carpooling support system, and the like.

The controller 230 (an example of a controller and a processing unit) is a general-purpose microcomputer including a CPU (central processing unit), a memory, and an input / output unit. A computer program (carpooling support program) for functioning as a part of the vehicle allocation server is installed in the controller 230. By executing the computer program, the controller 230 functions as a plurality of information processing circuits (231, 233, 235, 237).

Here, an example of realizing a plurality of information processing circuits (231, 233, 235, 237) included in the controller 230 by software is shown. However, it is also possible to configure an information processing circuit (231, 233, 235, 237) by preparing dedicated hardware for executing each of the following information processing. Further, a plurality of information processing circuits (231, 233, 235, 237) may be configured by individual hardware.

The controller 230 includes a vehicle allocation plan candidate management unit 231, a support content acquisition unit 233, a support availability confirmation unit 235, and a vehicle allocation plan setting unit 237 as the plurality of information processing circuits (231, 233, 235, 237).

The vehicle allocation plan candidate management unit 231 (vehicle allocation plan candidate management means) generates a vehicle allocation plan candidate based on the vehicle allocation request from the user. More specifically, the vehicle allocation plan candidate management unit 231 may generate one or a plurality of vehicle allocation plan candidates which satisfies vehicle allocation conditions (departure place, destination, departure time, arrival time, etc. desired by the user) included in the vehicle allocation request.

In addition, the vehicle allocation plan candidate management unit 231 may calculate an evaluation value based on the vehicle allocation condition with each vehicle allocation plan candidate to be generated. Further, the vehicle allocation plan candidate management unit 231 may calculate an evaluation value indicating that the higher the value, the more the vehicle allocation plan candidate conforms to the user’s vehicle allocation conditions.

The vehicle allocation plan candidate generated by the vehicle allocation plan candidate management unit 231 may be linked to vehicle allocation requests from a plurality of users. In this case, the vehicle allocation plan candidate management unit 231 may calculate a plurality of evaluation values for one vehicle allocation plan candidate in response to the vehicle allocation requests from the plurality of users.

For example, consider the case where there is a vehicle allocation request from the second user after a vehicle allocation request from the first user. In this case, the vehicle allocation plan candidate generated based on the vehicle allocation request from the first user may be modified to generate the vehicle allocation plan candidate generated based on the vehicle allocation request from the second user In this case, the modified vehicle allocation plan candidate is linked to both the vehicle allocation request from the first user and the vehicle allocation request from the second user. In particular, according to the modified vehicle allocation plan candidate, a timing may occur in which the first user and the second user board the same vehicle at the same time.

If there is the vehicle allocation request from the first user after the vehicle allocation request from the second user, the vehicle allocation plan candidate may be generated based on the vehicle allocation request from the first user by modifying the vehicle allocation plan candidate generated based on the vehicle allocation request from the second user. In this case as well, the modified vehicle allocation plan candidate is linked to both the vehicle allocation request from the first user and the vehicle allocation request from the second user. In particular, according to the modified vehicle allocation plan candidate, a timing may occur in which the first user and the second user board the same vehicle at the same time.

In the above description, the “modifying the vehicle allocation plan candidate” includes the concept of changing the passing point and the passing time of the vehicle 300, which are already included in the vehicle allocation plan candidate generated by the vehicle allocation plan candidate management unit 231. By “modifying the vehicle allocation plan candidate”, the vehicle allocation plan candidate management unit 231 generates a vehicle allocation plan candidate that satisfies the vehicle allocation condition included in the vehicle allocation request of the first user and the vehicle allocation condition included in the vehicle allocation request of the second user.

For the sake of explanation, the current location of the vehicle is marked as “C”, the boarding place of the first user is marked as “S1”, the alighting place of the first user is marked as “E1”, the boarding place of the second user is marked as “S2”, and the alighting place of the second user is marked as “E2”. If the vehicle allocation plan candidate based on the vehicle allocation request from the first user is a plan for the vehicle to travel on the route of: “C ➔S1 ➔E1”, after the modification, the vehicle allocation plan candidate may be modified as a plan on the route of:
“C ➔ S1 ➔ S2 ➔ E2 ➔ E1”,
“C ➔S2 ➔S1 ➔E1 ➔E2”,
“C ➔S1 ➔S2 ➔E1 ➔E2”, or
“C ➔ S2 ➔ S1 ➔ E2 ➔ E1”.
The vehicle allocation plan candidate (“C ➔S2 ➔E2”) based on the vehicle allocation request from the second user can also be modified in the same manner.

In addition, the vehicle allocation plan candidate may be modified as
“C ➔S1➔E1➔S2 ➔ E2” or
“C ➔ S2 ➔ E2 ➔ S1 ➔ E1”.
There is no timing for both the first user and the second user to board the same vehicle at the same time. Therefore, these cases are not the target of the carpooling support according to the present embodiment.

The vehicle allocation plan candidate management unit 231 generates or modifies one or a plurality of vehicle allocation plan candidates each time a vehicle allocation request from a user is received. That is, the vehicle allocation plan candidate to be managed by the vehicle allocation plan candidate management unit 231 may change at any time each time a vehicle allocation request is received.

When there is a vehicle allocation plan candidate linked to both the vehicle allocation request from the first user and the vehicle allocation request from the second user, the support content acquisition unit 233 (support content acquisition means) acquires a predetermined support required by the second user related to the vehicle allocation plan candidate, and generates a support request for the first user to consent to the predetermined support for the second user.

When there is a vehicle allocation plan candidate linked to both the vehicle allocation request from the first user and the vehicle allocation request from the second user, the support availability confirmation unit 235 (support availability confirmation means) transmits the support request generated by the support content acquisition unit 233 to the terminal 100 operated by the first user related to the vehicle allocation plan candidate. After that, the support availability confirmation unit 235 acquires the support availability data from the terminal 100.

The support availability confirmation unit 235 may transmit the support request to the terminal 100 before completing the reservation of the vehicle to be allocated based on the vehicle allocation request from the first user.

The support availability data acquired by the support availability confirmation unit 235 is transmitted to the vehicle allocation plan candidate management unit 231, and a combination data is generated by the vehicle allocation plan candidate management unit 231, wherein the combination data is a pair of the acquired support availability data and the vehicle allocation plan candidates related to the first user and the second user associated with the support availability data. The combination data is stored in the database 220.

The vehicle allocation plan setting unit 237 (vehicle allocation plan setting means) acquires information indicating whether or not to agree with the vehicle allocation plan candidate (plan consent approval / disapproval data), and sets the vehicle allocation plan candidate as a vehicle allocation plan based on the plan consent approval / disapproval data. Specifically, the vehicle allocation plan setting unit 237 refers to the acquired plan consent approval / disapproval data, and sets the vehicle allocation plan candidate agreed by the user as the vehicle allocation plan.

Further, the vehicle allocation plan setting unit 237 may transmit the set vehicle allocation plan to the terminal 100 and may present the set vehicle allocation plan to the user via the display unit 160.

In addition, in a case where the set vehicle allocation plan is a vehicle allocation plan linked to both the vehicle allocation request from the first user and the vehicle allocation request from the second user, the vehicle allocation plan setting unit 237 may transmit a user information of the second user (user name, gender, contact information, etc.) to the terminal 100 of the first user, and may notify the user information of the second user to the first user via the display unit 160. Further, at the same time, the vehicle allocation plan setting unit 237 may transmit a user information of the first user (user name, gender, contact information, support availability data, etc.) to the terminal 100, and may notify the user information of the first user to the second user is notified via the display unit 160.

If the second user sets not to allow disclosure own user information, the vehicle allocation plan setting unit 237 may notify an anonymous information anonymizing the user information of the second user to the first user instead of notifying the user information of the second user to the first user. If the first user sets not to allow disclosure own user information, the vehicle allocation plan setting unit 237 may notify an anonymous information anonymizing the user information of the first user and the support availability data to the second user instead of notifying the user information of the first user to the second user.

### Processing Procedure for Carpooling Support

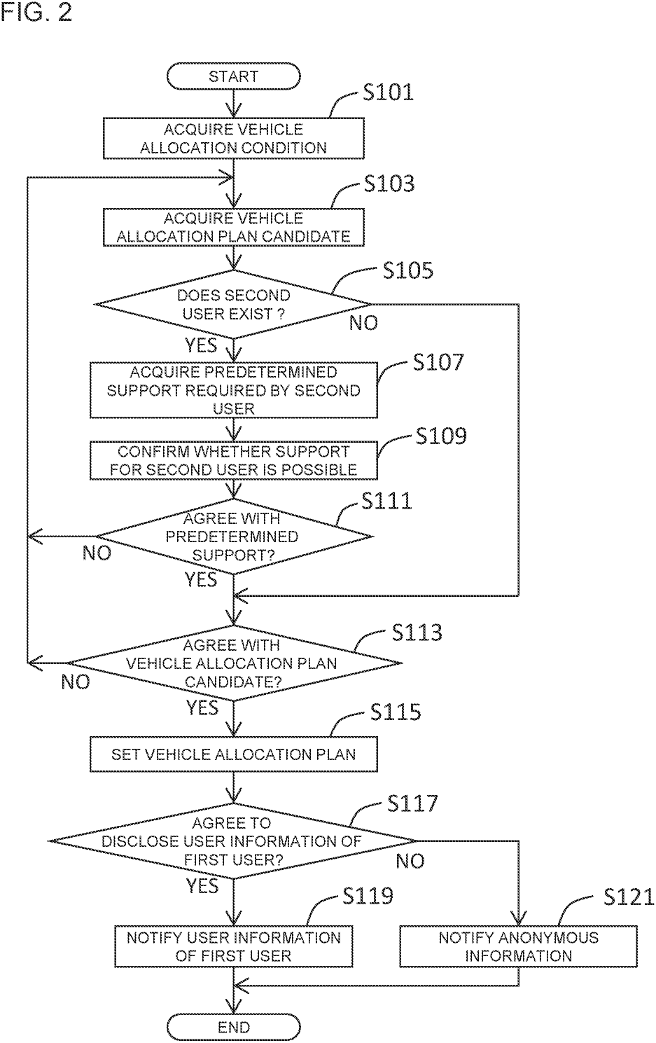

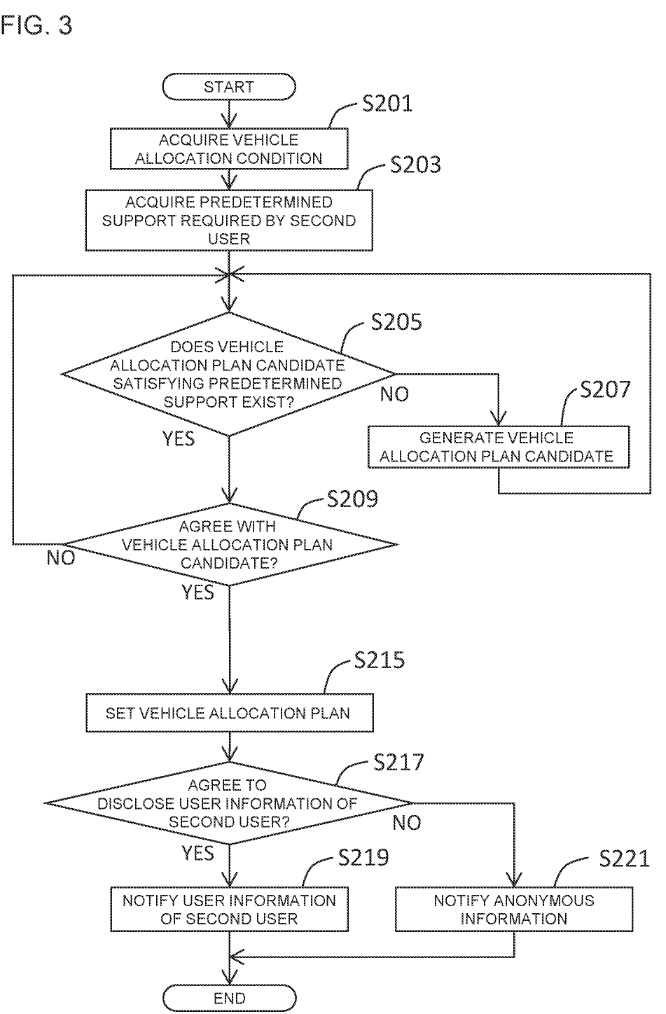

Next, the processing procedure for carpooling support according to the present embodiment will be described with reference to the flowcharts of FIGS. 2 and 3.

FIG. 2 is a flowchart illustrating a processing procedure related to a first user (supporter) side in a carpooling support according to the embodiment of the present invention. FIG. 3 is a flowchart illustrating a processing procedure related to a second user (support recipient) side in a carpooling support according to the embodiment of the present invention.

Here, the processing procedure shown in the flowchart of FIG. 2 is started at the timing of receiving the vehicle allocation request from the first user, and the processing procedure shown in the flowchart of FIG. 3 is started at the timing of receiving the vehicle allocation request from the second user.

Therefore, the processing procedure shown in the flowchart of FIG. 2 and the processing procedure shown in the flowchart of FIG. 3 can be executed in parallel. Either the processing procedure shown in the flowchart of F FIG. 2 or the processing procedure shown in the flowchart of FIG. 3 may be started first.

First, the flowchart of FIG. 2 will be described. In step S101, the vehicle allocation plan candidate management unit 231 reads the vehicle allocation request from the first user and acquires the vehicle allocation condition based on the vehicle allocation request. Then, the vehicle allocation plan candidate management unit 231 generates or modifies one or a plurality of vehicle allocation plan candidates associated with the first user based on the vehicle allocation conditions.

In step S103, the vehicle allocation plan candidate management unit 231 acquires one vehicle allocation plan candidate associated with the first user from one or the plurality of vehicle allocation plan candidates to be managed. The vehicle allocation plan candidate management unit 231 may acquire vehicle allocation plan candidates in descending order of evaluation value from the vehicle allocation plan candidates associated with the first user.

In step S105, the vehicle allocation plan candidate management unit 231 determines whether or not there is a second user associated with the acquired vehicle allocation plan candidate.

If it is determined that the second user does not exist (NO in step S105), the process proceeds to step S113.

On the other hand, if it is determined that the second user exists (YES in step S105), the process proceeds to step S107, and the support content acquisition unit 233 acquires a predetermined support required by the second user related to the acquired vehicle allocation plan candidate, and generates a support request for the first user to consent to the predetermined support for the second user

In step S109, the support availability confirmation unit 235 transmits the support request generated by the support content acquisition unit 233 to the terminal 100. Via the terminal 100, the first user inputs whether or not the first user agrees with the predetermined support indicated by the support request, and then the support availability confirmation unit 235 acquires the support availability data generated based on the input by the first user from the terminal 100.

In step S111, the support availability confirmation unit 235 determines whether or not the first user agrees with the acquired vehicle allocation plan candidate based on the support availability data.

If it is determined that the first user does not agree with the predetermined support based on the support availability data (NO in step S111), the acquired vehicle allocation plan candidate is excluded, and the process returns to step S103.

On the other hand, if it is determined that the first user agrees to the predetermined support based on the support availability data (YES in step S111), the vehicle allocation plan candidate management unit 231 generates a combination data which is a pair of the acquired vehicle allocation plan candidate and the support availability data, and then the process proceeds to step S113.

In step S113, the vehicle allocation plan setting unit 237 acquires the plan consent approval / disapproval data, and determines whether or not the first user agrees with the acquired vehicle allocation plan candidate based on the plan consent approval / disapproval data.

If it is determined that the first user does not agree with the vehicle allocation plan candidate based on the plan consent approval / disapproval data (NO in step S113), the acquired vehicle allocation plan candidate is excluded, and then the process returns to step S103.

On the other hand, if it is determined that the first user agrees with the vehicle allocation plan candidate based on the plan consent approval / disapproval data (YES in step S113), in step S115, the vehicle allocation plan setting unit 237 sets the acquired the vehicle allocation plan candidate as a vehicle allocation plan for the first user.

In step S117, the vehicle allocation plan setting unit 237 determines whether or not the first user agrees to disclose own user information. Specifically, the vehicle allocation plan setting unit 237 makes a determination based on the information at the time of registration for use in the carpooling support system or the information included in the vehicle allocation request.

If it is determined that the first user agrees to disclose own user information (YES in step S117), in step S119, the vehicle allocation plan setting unit 237 notifies the user information of the first user (user name, gender, contact information, support availability data, etc.) to the second user.

On the other hand, if it is determined that the first user does not agree to disclose own user information (NO in step S117), in step S121, the vehicle allocation plan setting unit 237 notifies an anonymous information anonymizing the user information of the first user and the support availability data to the second user.

Next, the flowchart of FIG. 3 will be described. In step S201, the vehicle allocation plan candidate management unit 231 reads the vehicle allocation request from the second user and acquires the vehicle allocation condition based on the vehicle allocation request.

In step S203, the support content acquisition unit 233 acquires the predetermined support required by the second user related to the vehicle allocation plan candidate.

In step S205, the vehicle allocation plan candidate management unit 231 determines whether or not the vehicle allocation plan candidate satisfying the predetermined support required by the second user exists in one or a plurality of vehicle allocation plan candidates associated with the second user. Specifically, the vehicle allocation plan candidate management unit 231 refers the combination data stored in the database 220, and determines whether or not there is a vehicle allocation plan candidate paired with the support availability data indicating consent to the predetermined support required by the second user.

If it is determined that there is no vehicle allocation plan candidate satisfying the predetermined support required by the second user (NO in step S205), in step S207, the vehicle allocation plan candidate management unit 231 generates one or a plurality of vehicle allocation plan candidates associated with the second user, based on the vehicle allocation condition.

When it is determined that there is a vehicle allocation plan candidate satisfying the predetermined support required by the second user (YES in step S205), in step S209, the vehicle allocation plan setting unit 237 acquires the plan consent approval / disapproval data, and determines whether or not the second user agrees with the acquired vehicle allocation plan candidate, based on the plan consent approval / disapproval data.

If it is determined that the second user does not agree with the acquired vehicle allocation plan candidate, based on the plan consent approval / disapproval data (NO in step S209), the acquired vehicle allocation plan candidate is excluded, and the process returns to step S205.

On the other hand, if it is determined that the second user agrees with the acquired vehicle allocation plan candidate, based on the plan consent approval / disapproval data (YES in step S209), in step S215, the vehicle allocation plan setting unit 237 sets the acquired the vehicle allocation plan candidate as the vehicle allocation plan for the second user.

In step S217, the vehicle allocation plan setting unit 237 determines whether or not the second user agrees to disclose own user information. Specifically, the vehicle allocation plan setting unit 237 makes a determination based on the information at the time of registration for use in the carpooling support system or the information included in the vehicle allocation request.

If it is determined that the second user agrees to disclose own user information (YES in step S217), in step S219, the vehicle allocation plan setting unit 237 notifies the user information of the second user (user name, gender, contact information, etc.) to the first user.

On the other hand, if it is determined that the second user does not agree to disclose own user information (NO in step S217), in step S221, the vehicle allocation plan setting unit 237 notifies an anonymous information anonymizing the user information of the second user to the first user.

### Effect of Embodiments

As described in detail above, a carpooling support method, a carpooling support device, and a carpooling support system according to the present embodiment generate a vehicle allocation plan candidate of a vehicle for a first user (supporter), based on a vehicle allocation request, transmits a support request for the first user to consent to a predetermined support for a second user (support recipient) of the vehicle, to an operation terminal, acquire a support availability data from the operation terminal, where the support availability data indicating whether consent to the predetermined support is possible, and record the vehicle allocation plan candidate and the support availability data in association with each other.

As a result, the cooperative relationship between the users can be reflected in the vehicle allocation plan, and the burden on the user who needs support when using the vehicle allocation service can be reduced. In addition, since the vehicle allocation plan candidate and the support availability data are recorded in association with each other, it is not necessary to refer to the vehicle allocation requests of multiple users again when calculating the vehicle allocation plan in which the support relationship is established among the multiple users, and thus, the calculation cost can be reduced.

Further, the carpooling support method, the carpooling support device, and the carpooling support system according to the present embodiment may transmit the support request to the operation terminal before completing a reservation of the vehicle to be allocated based on the vehicle allocation request. As a result, the first user can confirm whether or not it is necessary to assist the second user before the reservation of the vehicle to be allocated is completed. Further, the determination of the first user as to whether or not to support the second user can be reflected in the vehicle allocation plan.

In the carpooling support method, the carpooling support device, and the carpooling support system, the predetermined support may include assistance to the second user when the second user boards or alights the vehicle to be allocated based on the vehicle allocation request. This makes it easier for the second user to board or alight the vehicle with the support of the first user.

In the carpooling support method, the carpooling support device, and the carpooling support system, the predetermined support may include transfer of right regarding the vehicle to be allocated based on the vehicle allocation request, from the first user to the second user. As a result, the convenience of the second user while getting on the vehicle can be enhanced.

In the carpooling support method, the carpooling support device, and the carpooling support system, the right may include at least one of a right reserved by the first user to occupy a seat of the vehicle and a right reserved by the first user to occupy a space of the vehicle. As a result, with the support of the first user, it becomes possible to easily load the luggage and the like necessary for the support of the second user on the vehicle to be allocated. Furthermore, the convenience of the second user while getting on the vehicle can be enhanced.

Further, in carpooling support method, the carpooling support device, and the carpooling support system according to the present embodiment, the predetermined support may include generating a vehicle allocation plan that prioritizes the second user over the first user. As a result, the convenience of the second user while getting on the vehicle can be enhanced.

Further, the carpooling support method, the carpooling support device, and the carpooling support system according to the present embodiment may generate the vehicle allocation plan that prioritizes a seat reservation by the second user over a seat reservation by the first user. As a result, the convenience of the second user while getting on the vehicle can be enhanced.

Further, the carpooling support method, the carpooling support device, and the carpooling support system according to the present embodiment may generate the vehicle allocation plan that prioritizes boarding or alighting of the second user over boarding or alighting of the first user. This makes it possible to avoid a case where a position where it is difficult for the second user to get on or off is set as the boarding or alighting place of the second user. As a result, the convenience of the second user can be enhanced.

Further, in carpooling support method, the carpooling support device, and the carpooling support system according to the present embodiment, the second user includes at least one of: passengers who are equal to or older than a predetermined age, passengers who are equal to or younger than the predetermined age, passengers of a predetermined gender, and passengers who require a predetermined care.

Although the contents of the present invention have been described above with reference to the embodiment, the present invention is not limited to these descriptions, and it will be apparent to those skilled in the art that various modifications and improvements can be made. It should not be construed that the present invention is limited to the descriptions and the drawings that constitute a part of the present disclosure. On the basis of the present disclosure, various alternative embodiments, practical examples, and operating techniques will be apparent to those skilled in the art.

It is needless to mention that the present invention also includes various embodiments that are not described herein. Therefore, the technical scope of the present invention is to be defined only by the invention specifying matters according to the scope of claims appropriately obtained from the above descriptions.

Respective functions described in the above embodiment may be implemented by one or plural processing circuits. The processing circuits include programmed processing devices such as a processing device including an electric circuit. The processing circuits include devices such as an application specific integrated circuit (ASIC) and conventional circuit elements that are arranged to execute the functions described in the embodiment.

REFERENCE SIGNS LIST

| | |
|---|---|
| 100 | terminal (operation terminal) |
| 110 | communication unit |
| 130 | controller |
| 150 | sensor |
| 160 | display unit |
| 170 | operation unit |
| 200 | vehicle allocation server (carpooling support device) |
| 210 | communication unit |
| 220 | database (storage unit) |
| 230 | controller |
| 231 | vehicle allocation plan candidate management unit (vehicle allocation plan generation unit) |
| 233 | support content acquisition unit |
| 235 | support availability confirmation unit |
| 237 | vehicle allocation plan setting unit |
| 300 | vehicle |
| 400 | network |

1. A method of a device including a communication unit and a controller, the method performed by the controller comprising:
acquiring a vehicle allocation request from an operation terminal via the communication unit, wherein the vehicle allocation request includes a support availability data indicating whether or not consent to a predetermined support is possible,
generating a vehicle allocation plan candidate of a vehicle fora first user, based on the vehicle allocation request of the first user, wherein the vehicle allocation plan candidate is paired with the support availability data,
acquiring the predetermined support required by a second user of the vehicle,
determining existence of the vehicle allocation plan candidate satisfying the predetermined support the fist user consents and required by the second user, based on the support availability data, and
setting the vehicle allocation plan candidate determined to exist as a vehicle allocation plan of the vehicle for the second user.

2. The method according to claim 1, further comprising:
transmitting a support request for the first user to consent to the predetermined support to the operation terminal before completing a reservation of the vehicle to be allocated based on the vehicle allocation request of the first user.

3. The method according to claim 1, wherein
the predetermined support includes assistance to the second user when the second user boards or alights the vehicle to be allocated based on the vehicle allocation request of the first user.

4. The method according to claim 1, wherein
the predetermined support includes transfer of right regarding the vehicle to be allocated based on the vehicle allocation request of the first user, from the first user to the second user.

5. The method according to claim 4, wherein
the right includes at least one of a right reserved by the first user to occupy a seat of the vehicle and a right reserved by the first user to occupy a space of the vehicle.

6. The method according to claim 1, wherein
the predetermined support includes generating a vehicle allocation plan that prioritizes the second user over the first user.

7. The method according to claim 6, further comprising:
generating the vehicle allocation plan that prioritizes a seat reservation by the second user over a seat reservation by the first user.

8. The method according to claim 6, further comprising:
generating the vehicle allocation plan that prioritizes boarding or alighting of the second user over boarding or alighting of the first user.

9. The method according to claim 1, wherein
the second user includes at least one of:
passengers who are equal to or older than a predetermined age,
passengers who are equal to or younger than the predetermined age,
passengers of a predetermined gender, and
passengers who require a predetermined care.

10. A device comprising a communication,
wherein the controller
acquires a vehicle allocation request from an operation terminal via the communication unit, wherein the vehicle allocation request includes a support availability data indicating whether or not consent to a predetermined support is possible,
generates a vehicle allocation plan candidate of a vehicle fora first user, based on the vehicle allocation request of the first user, wherein the vehicle allocation plan candidate is paired with the support availability data,
acquires the predetermined support required by a second user of the vehicle,
determines existence of the vehicle allocation plan candidate satisfying the predetermined support the fist user consents and required by the second user, based on the support availability data, and
sets the vehicle allocation plan candidate determined to exist as a vehicle allocation plan of the vehicle for the second user.

11. A system comprising:
an operation terminal configured to transmit a vehicle allocation request by receiving request operation of a first user, and
a vehicle allocation server configured to allocate a vehicle based on the vehicle allocation request,
wherein the vehicle allocation server includes
a communication unit configured to acquire the vehicle allocation request and
a controller,
wherein the controller
acquires the vehicle allocation request from an operation terminal via the communication unit, wherein the vehicle allocation request includes a support availability data indicating whether or not consent to a predetermined support is possible,
generates a vehicle allocation plan candidate ofthe vehicle fora first user, based on the vehicle allocation request of the first user, wherein the vehicle allocation plan candidate is paired with the support availability data,
acquires the predetermined support required by a second user of the vehicle,
determines existence of the vehicle allocation plan candidate satisfying the predetermined support the fist user consents and required by the second user, based on the support availability data, and
sets the vehicle allocation plan candidate determined to exist as a vehicle allocation plan of the vehicle for the second user.

12. The method according to claim 1, further comprising:
setting the vehicle allocation plan candidate determined to exist as the vehicle allocation plan in a case where the second user agrees with the vehicle allocation plan candidate determined to exist.

13. The method according to claim 1, further comprising:
recording the vehicle allocation plan candidate and the support availability data in association with each other.

14. The method according to claim 1, further comprising:
transmitting a user information of the second user to the operation terminal of the first user in a case where the vehicle allocation plan is linked to both the vehicle allocation request from the first user and the vehicle allocation request from the second user.

15. The method according to claim 1, further comprising:
transmitting a user information of the first user to the operation terminal of the second user in a case where the vehicle allocation plan is linked to both the vehicle allocation request from the first user and the vehicle allocation request from the second user.
